(19) United States
(12) Patent Application Publication
(10) Pub. No.: US 2015/0079341 A1
(43) Pub. Date: Mar. 19, 2015

(54) FABRICATION METHOD OF RESIN COMPACT, RESIN COMPACT, AND MOLD

(71) Applicants: Tokyo University of Science Foundation, Shinjuku-ku (JP); KURARAY Co., Ltd., Kurashiki-shi (JP)

(72) Inventors: Go TAZAKI, Tsukuba-shi (JP); Toshiyuki Zento, Tsukuba-shi (JP); Jun Taniguchi, Shinjuku-ku (JP)

(73) Assignees: Tokyo University of Sci. Ed. Foundation Admin. Org, Shinjuku-ku (JP); KURARAY Co., Ltd., Kurashiki-shi (JP)

(21) Appl. No.: 14/028,007

(22) Filed: Sep. 16, 2013

(51) Int. Cl. B29C 59/02; B29C 33/58

(52) U.S. Cl. CPC B29C 59/022; B29C 33/58; B29C 2059/023
USPC 428/141; 264/293; 425/385

(57) ABSTRACT

Disclosed is fabrication of a resin compact using a mold.

The mold includes a resin mold body satisfies any one of conditions which are:
a width of a protrusion is 5 nm or greater and less than 50 nm, an aspect ratio of the protrusion is 2 or greater, and Martens hardness is 200 or greater;
the width of the protrusion is 50 nm or greater and less than 100 nm, the aspect ratio of the protrusion is 3 or greater, and Martens hardness is 200 or greater; and
the width of the protrusion is 100 nm or greater and less than 1 μm, the aspect ratio of the protrusion is 4 or greater, and Martens hardness is 150 or greater.

The inversion pattern has a space between the adjacent protrusions less than twice a height of the protrusion.

The mold further includes an adhesion layer and a release layer.

### BACKGROUND OF THE INVENTION

1. Field of the Invention

The present invention relates to a fabrication method of a resin compact including an uneven pattern on its surface, the resin compact, and a mold preferably used for fabricating the resin compact.

2. Description of Related Art

In recent years, as the functions and performance of products advance, there has been active development research focusing on features peculiar to nanostructures all over the world in a wide range of fields such as IT, environment and energy, and biomedical. For example, light is unable to recognize a nanostructure smaller than a wavelength as a structure. It is thus possible to control refraction, reflection, diffraction and the like by the use of nanostructures. Under such a circumstance, a resin compact is attracting attentions that has an uneven pattern on its surface (hereinafter the uneven pattern may be referred to as a nanopattern).

As a fabrication method of the above-mentioned resin compact, there is the nanoimprint method that uses a mold including an inversion pattern of a desired pattern and transfers the pattern to resin (see “Development of Nanoimprint and Device Applications”, pp. 211-212, CMC Publishing Co., Ltd.).

A resin mold is preferable as the above-mentioned mold in light of lower manufacturing cost of a resin compact. Unlike a non-resin mold, a resin mold is flexible and hard to break, and thus one mold can be used for pattern transfer to resin for more number of times to thereby reduce the mold cost. Moreover, by the use of a resin mold, a resin compact can be fabricated by a continuous process such as the roll-to-roll processing, thereby reducing the fabrication cost of the resin compact.

The resin mold can be fabricated, for example, by surface patterning using a well-known lithography method on a non-resin substrate such as silicon, glass, or nickel and transferring a pattern, using the patterned substrate as a master mold, to resin by the nanoimprint method. A layer such as a release layer may be formed over a surface of the resin mold as necessary.

In a fabrication process of a resin mold by the nanoimprint method or in a process of laminating layers such as a release layer over a surface of a resin mold, in the case of a nanopattern that has a high aspect ratio of protrusion and small space between adjacent protrusions relative to the height of the protrusion, adjacent protrusions are likely to associate (bond) each other. Sticking particularly occurs on a nanopattern with a high aspect ratio of the protrusion, small space between the adjacent protrusions relative to the height of protrusion, and a side surface is upright or almost upright on a bottom surface of depression.

Specifically, the above-mentioned sticking tends to occur on a nanopattern that satisfies any one of the conditions which are: the width of protrusion is 5 nm or greater and less than 50 nm and the aspect ratio of the protrusion is 2 or greater; the width of protrusion is 50 nm or greater and less than 100 nm and the aspect ratio of the protrusion is 3 or greater; and the width of protrusion 100 nm or greater and less than 1 μm and the aspect ratio of the protrusion is 4 or greater. Further, in addition to any one of the above conditions, on the nanopattern, the spaces between the adjacent protrusions is less than twice the height of the protrusion.

In this specification, “an upright or almost upright nanopattern” is, to be specific, a pattern in which an angle of a side surface of a protrusion to a bottom surface of a depression is 80 to 90 degrees.

From the above reason, the fabrication method of a resin compact by the nanoimprint method including a high aspect ratio nanopattern has not currently been put into practical use.

### SUMMARY OF THE INVENTION

The present invention is made in view of the above-mentioned circumstances, and an object of the present invention is to provide a fabrication method of a resin compact that is capable of fabricating a resin compact including a high aspect ratio nanopattern by the nanoimprint method without sticking, and a mold suitable for use in the fabrication method.

An aspect of the present invention is a method of fabricating a resin compact including an uneven pattern on a surface.

The method includes a process (A) that prepares a resin mold body including an inversion pattern of the uneven pattern and prepares a mold including an adhesion layer and a release layer that are sequentially laminated over the inversion pattern according to a pattern shape of the inversion pattern.

The inversion pattern includes a plurality of depressions and a plurality of protrusions, satisfies any one of conditions which are:
a width of the protrusion is 5 nm or greater and less than 50 nm and an aspect ratio of the protrusion is 2 or greater;
the width of the protrusion is 50 nm or greater and less than 100 nm and the aspect ratio of the protrusion is 3 or greater; and
the width of the protrusion is 100 nm or greater and less than 1 μm and the aspect ratio of the protrusion is 4 or greater.

The inversion pattern has a space between the adjacent protrusions less than twice a height of the protrusion, and the inversion pattern has Martens hardness of 200 or greater when the width of the protrusion is 5 nm or greater and less than 100 nm and Martens hardness of 150 or greater when the width of the protrusion is 100 nm or greater and less than 1 μm.

The method further includes a process (B) that supplies curable resin on the inversion pattern of the mold and cures the curable resin to thereby form the resin compact over the mold and

a process (C) that releases the resin compact from the mold.

The “adhesion layer” in this specification is a layer to improve adhesion between the mold body and the “release layer”.

The fabrication method of the resin compact according to the present invention is especially suitable for application when the above-mentioned inversion pattern is a pattern in which an angle of a side surface of the protrusion to a bottom surface of the depression is 80 to 90 degrees.

The resin compact according to the present invention is fabricated by the above-mentioned fabrication method of the resin compact.

Another aspect of the present invention is a mold used for fabricating a resin compact including an uneven pattern on a surface.

The mold includes a resin mold body including an inversion pattern of the uneven pattern.

The inversion pattern includes a plurality of depressions and a plurality of protrusions and satisfies any one of conditions which are:
a width of the protrusion is 5 nm or greater and less than 50 nm and an aspect ratio of the protrusion is 2 or greater;
the width of the protrusion is 50 nm or greater and less than 100 nm and the aspect ratio of the protrusion is 3 or greater; and
the width of the protrusion is 100 nm or greater and less than 1 μm and the aspect ratio of the protrusion is 4 or greater.

The inversion pattern has a space between the adjacent protrusions less than twice a height of the protrusion, and the inversion pattern has Martens hardness of 200 or greater when the width of the protrusion is 5 nm or greater and less than 100 nm and Martens hardness of 150 or greater when the width of the protrusion is 100 nm or greater and less than 1 μm.

The mold further includes an adhesion layer and a release layer that are sequentially laminated over the inversion pattern according to a pattern shape of the inversion pattern.

The mold according to the present invention is especially suitable for application when the above-mentioned inversion pattern is a pattern in which an angle of a side surface of the protrusion to a bottom surface of the depression is 80 to 90 degrees.

According to the present invention, it is possible to provide a fabrication method of a resin compact that is capable of fabricating a resin compact including a high aspect ratio nanopattern by the nanoimprint method without sticking and a mold suitable for use in the fabrication method.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a schematic cross-sectional diagram showing main parts of a resin compact according to an embodiment of the present invention;

FIG. 2 is a schematic cross-sectional diagram showing main parts of a mold according to an embodiment of the present invention;

FIG. 3 is a schematic cross-sectional diagram showing main parts of a mold body composing the mold of FIG. 2;

FIG. 4 is a schematic diagram showing an example of a fabrication apparatus by the roll-to-roll processing for the resin compact of FIG. 1;

FIG. 5 is an SEM photograph of a mold according to an example 2; and

FIG. 6 is an SEM photograph of a mold according to a comparative example 3.

### DESCRIPTION OF THE EXEMPLARY EMBODIMENTS

### “Fabrication Method of Resin Compact”

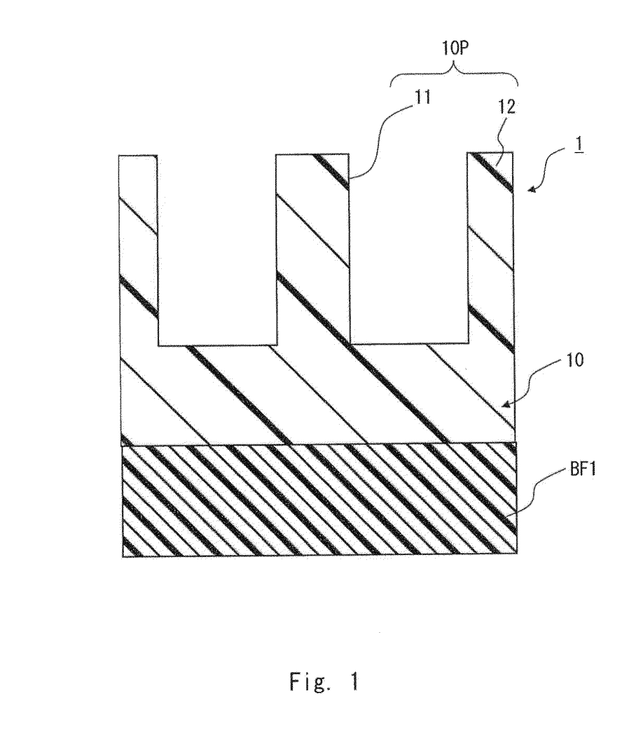

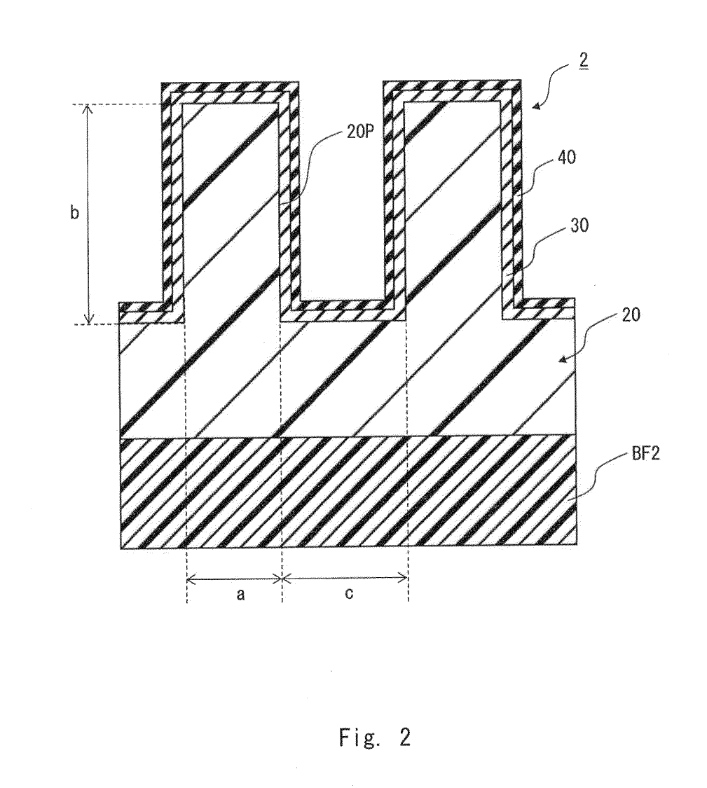

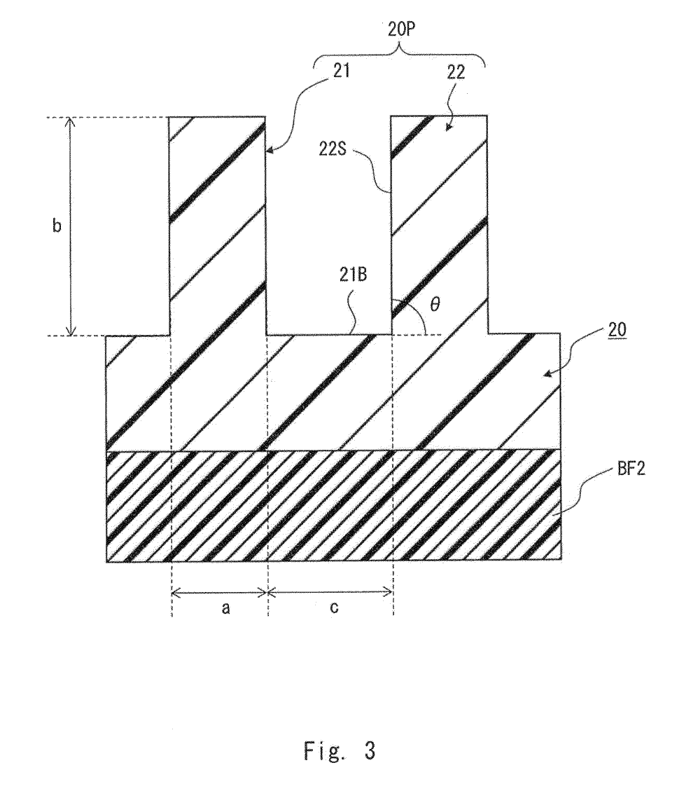

Explained below is a fabrication method of a resin compact according to an embodiment of the present invention, a resin compact fabricated by the fabrication method according to this embodiment, and a mold used in the fabrication method according to this embodiment. FIG. 1 is a cross-sectional diagram showing main parts of the resin compact according to this embodiment. FIG. 2 is a cross-sectional diagram showing main parts of the mold according to this embodiment. FIG. 3 is a cross-sectional diagram of the mold body composing the mold shown in FIG. 2. FIGS. 1 to 3 are schematic diagrams. The scales and the like of the components are different from actual ones as appropriate.

A resin compact 1 shown in FIG. 1 includes a nano-order uneven pattern (a nanopattern) 10P having a plurality of depressions 11 and a plurality of protrusions 12. The resin compact 1 is fabricated by the nanoimprint method using a mold 2 shown in FIG. 2. As shown in the drawings, the resin compact 1 is preferably fabricated in a configuration including a base film BF1.

The mold 2 shown in FIG. 2 includes a mold body 20 that is made of resin including an inversion pattern 20P of the uneven pattern 10P and an adhesion layer 30 and a release layer 4 that are sequentially laminated over the inversion pattern 20P according to a pattern shape of the inversion pattern 20P. As shown in the drawings, the mold body 20 and the mold 2 are preferably fabricated in a configuration with a base film BF 2.

As shown in FIG. 3, the inversion pattern 20P of the mold body 20 includes a plurality of depressions 21 and a plurality of protrusions 22. The inversion pattern 20 satisfies any one of the following conditions. The conditions are; a width a of the protrusion 22 is 5 nm or greater and less than 50 nm and the aspect ratio of the protrusion 22 is 2 or greater; the width a of the protrusion 22 is 50 nm or greater and less than 100 nm and the aspect ratio of the protrusion 22 is 3 or greater; and the width a of the protrusion 22 is 100 nm or greater and less than 1 μm and the aspect ratio of the protrusion 22 is 4 or greater. In addition to any one of the following conditions, on the inversion pattern 20P, a space c of the adjacent protrusions 22 is less than twice a height b of the protrusion 22, which indicates a nanopattern with a high aspect ratio. The aspect ratio here is a parameter calculated by the height b/the width a.

In this embodiment, as for the mold body 20, the Martens hardness shall be 200 or greater when the width of the protrusion 22 is 5 nm or greater and less than 100 nm, and the Martens hardness shall be 150 or greater when the width of the protrusions 22 is 100 nm or greater and less than 1 urn. This achieves sufficient rigidity of the mold body 20. This further suppresses sticking between the adjacent protrusions 22 that compose a nanopattern and thus stably achieves a desired pattern even for an upright or almost upright nanopattern with a high aspect ratio in a fabrication process of the mold body 20 and a lamination process of the adhesion layer 30 or the release layer 40 over the mold body 20.

The adhesion layer 30 is a layer to improve adhesion between the mold body 20 and the release layer 40. As the adhesion layer 30, a layer containing metal and/or metal oxide is preferable, for example. As the adhesion layer 30, a layer containing one kind or two or more kinds of metal, such as W, Pt, Ag, Cr, Ni, Al, and Cu and/or metal oxide thereof is preferable. The adhesion layer 30 may be a surface modification layer obtained by modifying a surface of the mold body 20 by oxygen plasma, excimer laser, ozone or the like. As the adhesion layer 30, a layer containing metal and/or metal oxide is especially preferable. The adhesion layer 30 made of such a layer can improve the rigidity of the mold 2. This therefore is preferable for a high aspect ratio upright or almost upright nanopattern as it is possible to effectively suppress sticking between the adjacent protrusions 22 composing the nanopattern in the fabrication process of the mold body 20 and the lamination process of the adhesion layer 30 or the release layer 40 over the mold body 20. The thickness of the adhesion layer 30 is not especially limited. A preferable thickness of the adhesion layer 30 is, for example, 1 to 25% of the space c between the adjacent protrusions 22.

The release layer 40 is a layer to improve release properties of the resin compact 1 from the mold 2. As the release layer 40, a layer containing one kind or two or more kinds of release agents, such as a fluorine series, a silicone series, or a hydrocarbon series is preferable. The present inventors have found out that when the release layer 40 is not separately formed and a release agent is added inside the resin mold body, it is difficult, for unknown reasons, to favorably fill resin inside the depressions on a high aspect ratio pattern. This is presumed to be due to the influence of surface tension of the internal mold release agent. In this embodiment, the release layer 40 is separately provided over the surface of the resin mold body 20 instead of adding a release agent inside the resin mold body. In this configuration, it is possible to favorably fill the resin inside the depressions 21 even for a high aspect ratio pattern and enables stable fabrication of the resin compact 1 in a desired shape. Note that the release layer 40 for improving release properties of resin has poor adhesion with the resin mold body 20, thus in this embodiment, the above-mentioned adhesion layer 30 is provided between the resin mold body 20 and the release layer 40. The thickness of the release layer 40 is not especially limited. A preferable thickness of the release layer 40 is, for example, 1 to 25% of the space c between the adjacent protrusions 22.

There is no particular limitation on the base film BF2, which is used as necessary, and may be made of, for example, polyethylene terephthalate (PET), carbonate resin, acrylic resin, or the like.

As shown in the drawings, the present invention is especially suitable for application when the inversion pattern 20P of the mold 2 is a pattern in which an angle θ of a side surface 22S of the depression 22 to a bottom surface 21B of the depression 21 is 80 to 90 degrees (an upright or almost upright pattern). A case of an upright pattern is shown here. Note that as shown in the drawings, the angle θ is an angle of a virtual line extending inside the protrusion 22 from a section line of the bottom surface 21 of the depression 21 to the side surface 22S of the protrusion 22. There is no particular limitation on a planar shape of the protrusions 22. The protrusions 22 may be any shapes such as a linear shape, a circular shape, and a rectangular shape. In the mold body 20, the widths a and the heights b of the protrusions 22 and the spaces c of the adjacent protrusions 22 may be substantially uniform or may not be uniform on the whole mold body 20.

A fabrication method of the resin compact 1 according to this embodiment includes a process (A) for preparing the above-mentioned mold 2, a process (B) for supplying curable resin over the inversion pattern 20P of the mold 2, curing the curable resin, and forming the resin compact 1 over the mold 2, and a process (C) for releasing the resin compact 1 from the mold 2.

The fabrication method of the mold 2 is not especially limited. Hereafter, an example of the fabrication method of the mold 2 is explained.

First, prepare the mold body 20. Perform surface patterning by a well-known lithography method on a non-resin substrate such as a silicon substrate, a glass substrate, a quartz substrate, and a nickel substrate. Use the patterned substrate as a master mold, transfer a pattern to curable resin by the nanoimprint method to thereby fabricate the resin mold body 20 including the inversion pattern 20P on the surface.

As the lithography method, there are the top-down lithography method using an energy line such as an electron beam and the bottom-up lithography method using arrays of microphase separated structure such as nanoparticles and block copolymer.

There is no particular limitation on the curable resin. There are, for example, thermosetting resin and energy line curable resin that is cured by energy line irradiation such as ultraviolet rays. The energy line curable resin is preferable.

The mold used for fabricating the resin mold body 20 may be a resin replica mold obtained using the above-mentioned mater mold.

When the Martens hardness after curing the mold body 20 is insufficient, the plurality of protrusions 22 composing the mold body 20 may stick to each other in the fabrication method of the mold body 20 by the nanoimprint method (see a comparative example 1 below). In this embodiment, the Martens hardness after curing the mold body 20 is set so as not to cause the sticking between the plurality of protrusions 22 composing the mold body 20 in the fabrication process of the mold body 20 by the nanoimprint method.

Next, the adhesion layer 30 is formed on the inversion pattern 20P of the mold body 20 according to a pattern shape of the inversion pattern 20P. When the adhesion layer 30 is made of metal and/or metal oxide, the adhesion layer 30 can be formed by the gas phase method such as sputtering. The adhesion layer 30 formed of a surface modification layer can be formed by processing the surface of the mold body 20 by oxygen plasma, excimer laser, ozone, or the like.

Next, the release layer 40 is formed on the adhesion layer 30. For example, the mold body 20 with the adhesion layer 30 formed thereon is immersed in liquid containing a release agent, rinsed as necessary, and dried to thereby form the release layer 40. When the Martens hardness of the mold body 20 is insufficient, the plurality of protrusions 22 composing the mold body 20 may stick to each other in the lamination process of the release layer 40 (see comparative examples 2 and 3 described later). In this embodiment, the Martens hardness after curing the mold body 20 is set so as not to cause the sticking between the plurality of protrusions 22 composing the mold body 20 in the laminating process of the release layer 40.

In this embodiment, since the mold body 20 is made of resin, the processes (B) and (C) can be conducted by the roll-to-roll processing.

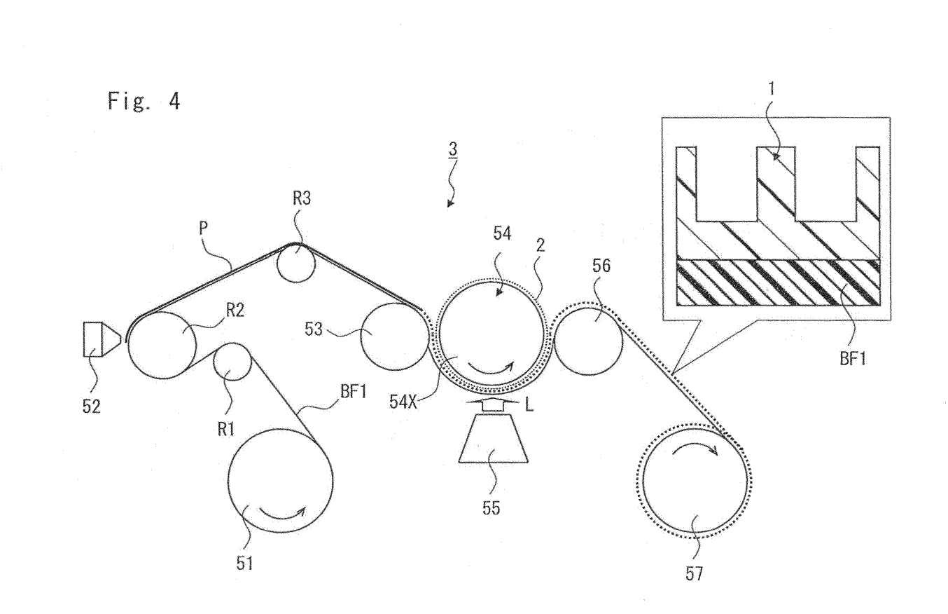

For example, the resin compact 1 can be fabricated using a fabrication apparatus 3 shown in FIG. 4. FIG. 4 is a schematic diagram showing a state of fabricating the resin compact 1. Here, the plurality of protrusions composing the uneven pattern of the resin compact 1 and the mold 2 are schematically shown as dots. The portion below the protrusions is not shown in FIG. 4. There is actually no space between the base film BF1 and curable resin P, between the base film BF1 and the resin compact 1, and between a roll body 54X composing a transferring roll 54 and the mold 2. However for better visuality, spaces are illustrated in FIG. 4.

Curable resin is used as raw resin of the resin compact 1. There is no particular limitation on the curable resin. There are, for example, thermosetting resin and energy line curable resin that is cured by energy line irradiation such as ultraviolet rays. The energy line curable resin is preferable.

The fabrication apparatus 3 is an example of an apparatus that uses energy line curable resin as the raw resin of the resin compact 1.

The fabrication apparatus 3 includes a roll 51 that feeds the base film BF1, a die 52 that supplies the curable resin P on the base film BF1, a nip roll 53 that supplies the curable resin P on the mold 2, the transferring roll 54 (the base film 2 is not shown in FIG. 4) to which a mold with a base film, which is the mold 2 with the base film BF2 formed thereon, is attached, an energy line irradiating apparatus 55 for irradiation with an energy line L for curing resin such as ultraviolet rays, a roll 56 that releases the resin compact 1 formed over the mold 2 from the mold 2, a roll 57 that winds the resin compact 1 with the base film, which is the base film BF1 with the resin compact 1 formed on the surface, and carrier rolls R1 to R3.

The fabrication apparatus 3 shown in FIG. 4 fabricates the resin compact 1 in the following manner. The curable resin P (the energy line curable resin in the example of FIG. 4) is supplied from the die 52 on the base film BF1 that is fed from the roll 51. The curable resin P is supplied by the nip roll 53 on the transferring roll 54 attached with the mold 2 on the surface. The curable resin P supplied on the transferring roll 54 is cured by irradiation with the energy line L from the energy line irradiation apparatus 55. The resin compact 1 is formed over the mold 2 by these processes. The resin compact 1 is released from the mold 2 by the roll 56. The resin compact 1 released from the mold 2 is wound on the roll 57 with the base film BF1 attached thereon.

The roll-to-roll processing is a preferable fabrication process of the resin compact 1, however the reel-to-reel processing or the batch press processing may also be used.

As explained above, according to this embodiment, it is possible to provide the fabrication method of the resin compact 1 that is capable of fabricating the resin compact 1 including a high aspect ratio nanopattern by the nanoimprint method without sticking and the mold 2 suitable for use in the fabrication method.

According to this embodiment, it is possible to provide the fabrication method of the resin compact 1 that is capable of fabricating the resin compact 1 including a high aspect ratio upright or almost upright nanopattern by the nanoimprint method without sticking and the mold 2 suitable for use in the fabrication method.

### EXAMPLES

Hereinafter, an example, a reference example, and comparative examples according to the present invention are explained. Each of the examples fabricated a resin compact having a cross-sectional pattern as the one shown in FIG. 1.

Explained below are fabrication of a master mold and a measurement method of the Martens hardness in each of the examples.

### [Fabricating a Master Mold]

An electron beam resist was spin-coated on a silicon (Si) substrate, electron beam was written on a resist surface by an electron beam writing apparatus, and the resist was developed so as to form a plurality of trench (line) patterns on the resist that reach to the surface of the Si substrate. A three-dimensional resist pattern was thus obtained. This three-dimensional resist pattern was used as a mask, reactive species and an opening portion of the Si substrate are reacted in a dry etching apparatus, and the surface of the Si substrate was etched. The resist pattern was removed by oxygen plasma to thereby obtain a master mold made of Si including, on its surface, a substantially upright nanopattern in which an angle of a side surface of a protrusion to a bottom surface of a depression was substantially 90 degrees. This master mold was immersed in an OPTOOL solution manufactured by Daikin Industries, Ltd. for a predetermined time, taken out, rinsed, and dried to thereby form a release layer according to a surface shape of the master mold.

### [Measuring Martens Hardness]

Energy line curable resin was irradiated with an energy line for a predetermined time to fabricate a measurement sample. In a nanoindentation apparatus, an indenter is pressed against a sample surface under conditions of a load 300 mN and for 20 seconds, and the Martens hardness is calculated by well-known method using an indentation depth.

### Example 1

A master mold made of Si was fabricated by the above-mentioned method. The master mold includes a substantially upright nanopattern that has a linear shape in a planar view and, in a cross-sectional view, the width of protrusion=50 nm, the height of protrusion=150 nm, the space between the adjacent protrusions=50 nm, and the aspect ratio of the protrusion=3.

Next, ultraviolet curable resin (urethane acrylate series, UV50-1 formulated by the Applicant) having the Martens hardness of 200 after being cured was dropped on the nanopattern of the master mold, a curable resin layer is formed, and a polyethylene terephthalate (PET) resin layer having 100 μm thickness is laminated on the curable resin layer as a base film. A glass substrate of about 50 g in weight was placed on the above PET resin layer, and the curable resin layer was irradiated with a predetermined amount of ultraviolet rays having a center wavelength of 365 nm. After the resin was cured, the resin was released from the master mold, thereby obtaining a mold body with the base film. From an observation of a pattern shape of the mold body by a scanning electron microscope (SEM), it was confirmed that the pattern shape was faithful to the pattern shape of the master mold, and the protrusions were substantially upright.

Next, a platinum film of 10 nm or less thickness is formed by a sputtering apparatus as an adhesion layer on the surface of the mold body with the base film. The mold body with the platinum film formed thereon was immersed in an OPTOOL solution for a predetermined time, taken out, rinsed, and dried to thereby obtain the mold with the base film and a release layer formed over the surface. From an SEM observation of the pattern shape of the mold, it was confirmed that the protrusions were substantially upright.

The above-mentioned mold with the base film was applied to a surface of a copper roll body with a 50 mm width to thereby obtain a transferring roll. A pattern was transferred to ultraviolet curable resin using a roll transfer apparatus manufactured by Mitsui Electric Co., Ltd. Conditions for transfer were:

Ultraviolet curable resin: PAK-01 manufactured by Toyo Gosei Co., Ltd.,
a rotating speed of the transfer roll: 10 mm/sec,
nip pressure during transfer: 0.3 MPa, and
illuminance of ultraviolet rays: 85 mW/cm².

The resin compact with the base film having the cross-sectional pattern as shown in FIG. 1 was obtained in this way. From an SEM observation of the pattern shape of the obtained resin compact, it was confirmed that the protrusions were substantially upright.

### Reference Example 1

A master mold made of Si was fabricated by the above-mentioned method. The master mold includes a substantially upright nanopattern that has a linear shape in a planar view and, in a cross-sectional view, the width of protrusion=50 nm, the height of protrusion=100 nm, the space between the adjacent protrusions=50 nm, and the aspect ratio of the protrusion=2.

Next, in a similar manner to the example 1 except for using, as the ultraviolet curable resin, ultraviolet curable resin (PAK-01 manufactured by Toyo Gosei Co., Ltd) having the Martens hardness of 120 after being cured, the mold body with the base film was obtained. From an SEM observation of the pattern shape of the mold body, it was confirmed that the pattern shape of the mold body was faithful to the pattern shape of the master pattern, and the protrusions of the pattern were substantially upright.

Next, in a similar manner to the example 1, an adhesion layer and a release layer were sequentially laminated over the surface of the mold body with the base film so as to obtain a mold with the base film. From an SEM observation of the pattern shape of the mold, it was confirmed that the protrusions were substantially and favorably upright. Next, in a similar to the example 1 except for using the above-mentioned mold with the base film, a pattern was transferred to ultraviolet curable resin to thereby obtain a resin compact with the base film. From an SEM observation of the pattern shape of the obtained resin compact, it was confirmed that the protrusions of the pattern were substantially upright.

### Comparative Example 1

A master mold made of Si was fabricated by the above-mentioned method. The master mold includes a substantially upright nanopattern that has a linear shape in a planar view and, in a cross-sectional view, the width of protrusion=50 nm, the height of protrusion=150 nm, the space between the adjacent protrusions=50 nm, and the aspect ratio of the protrusion=3.

Next, in a similar manner to the example 1 except for using, as the ultraviolet curable resin, ultraviolet curable resin (PAK-01 manufactured by Toyo Gosei Co., Ltd) having the Martens hardness of 120 after being cured, the mold body with the base film was obtained. The surface of the mold body was bleached in a macroscopic observation. From an SEM observation of the pattern shape of the mold body, sticking occurred in which the adjacent protrusions were associated and a substantial upright pattern was not achieved. In this example, sticking occurred in the fabrication process of the mold body using the master mold.

### Comparative Example 2

A master mold made of Si was fabricated by the above-mentioned method. The master mold includes a substantially upright nanopattern that has a linear shape in a planar view and, in a cross-sectional view, the width of protrusion=50 nm, the height of protrusion=150 nm, the space between the adjacent protrusions=50 nm, and the aspect ratio of the protrusion=3. Next, in a similar manner to the example 1 except for using, as the ultraviolet curable resin, ultraviolet curable resin (trimethylolpropane triacrylate series, UV50-2 formulated by the Applicant) having the Martens hardness of 180 after being cured, the mold body with the base film was obtained. From an SEM observation of the pattern shape of the mold body, it was confirmed that the pattern shape of the mold body was faithful to the pattern shape of the master mold, and the protrusions were substantially upright.

Next, in a similar manner to the example 1, an adhesion layer and a release layer were sequentially laminated over the surface of the mold body with the base film so as to obtain a mold with the base film. The surface of the mold body was bleached in a macroscopic observation. From an SEM observation of the pattern shape of the mold body, sticking occurred in which the adjacent protrusions were associated and a substantial upright pattern was not achieved. In this example, sticking occurred in the lamination process of the release layer during fabrication of the mold.

### Example 2

A master mold made of Si was fabricated by the above-mentioned method. The master mold includes a substantially upright nanopattern that has a linear shape in a planar view and, in a cross-sectional view, the width of protrusion=100 nm, the height of protrusion=400 nm, the space between the adjacent protrusions=100 nm, and the aspect ratio of the protrusion=4.

Next, in a similar manner to the example 1 except for using, as the ultraviolet curable resin, ultraviolet curable resin (trimethylolpropane triacrylate series, UV50-3 formulated by the Applicant) having the Martens hardness of 150 after being cured, the mold body with the base film was obtained. From an SEM observation of the pattern shape of the mold body, it was confirmed that the pattern shape of the mold body was faithful to the pattern shape of the master pattern, and the protrusions of the pattern were substantially upright.

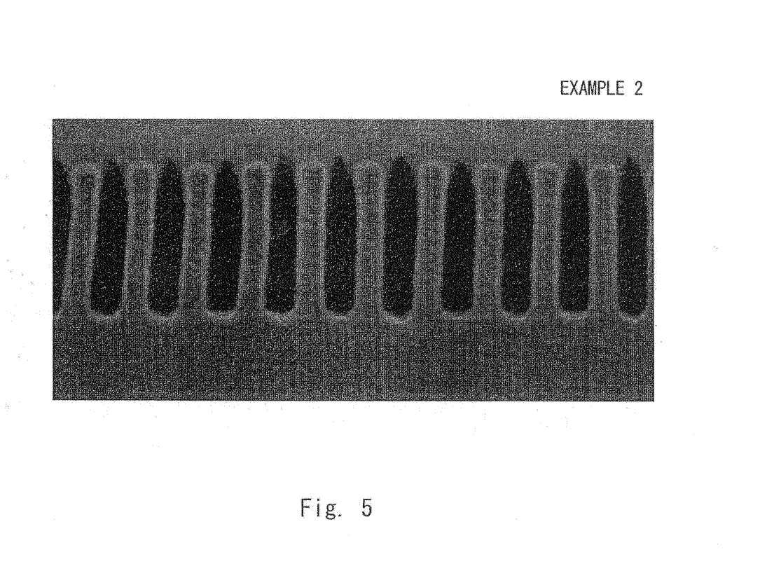

Next, in a similar manner to the example 1, an adhesion layer and a release layer were sequentially laminated over the surface of the mold body with the base film so as to obtain a mold with the base film. From an SEM observation of the pattern shape of the mold, it was confirmed that the protrusions were substantially and favorably upright. FIG. 5 is an SEM cross-sectional photograph of the mold. Next, in a similar to the example 1 except for using the above-mentioned mold with the base film, a pattern was transferred to ultraviolet curable resin to thereby obtain a resin compact with the base film. From an SEM observation of the pattern shape of the obtained resin compact, it was confirmed that the protrusions of the pattern were substantially upright.

### Comparative Example 3

A master mold made of Si was fabricated by the above-mentioned method. The master mold includes a substantially upright nanopattern that has a linear shape in a planar view and, in a cross-sectional view, the width of protrusion=100 nm, the height of protrusion=400 nm, the space between the adjacent protrusions=100 nm, and the aspect ratio of the protrusion=4.

Next, in a similar manner to the example 1 except for using, as the ultraviolet curable resin, ultraviolet curable resin (trimethylolpropane triacrylate series, UV50-4 formulated by the Applicant) having the Martens hardness of 130 after being cured, the mold body with the base film was obtained. From an SEM observation of the pattern shape of the mold body, it was confirmed that the pattern shape of the mold body was faithful to the pattern shape of the master mold, and the protrusions were substantially upright.

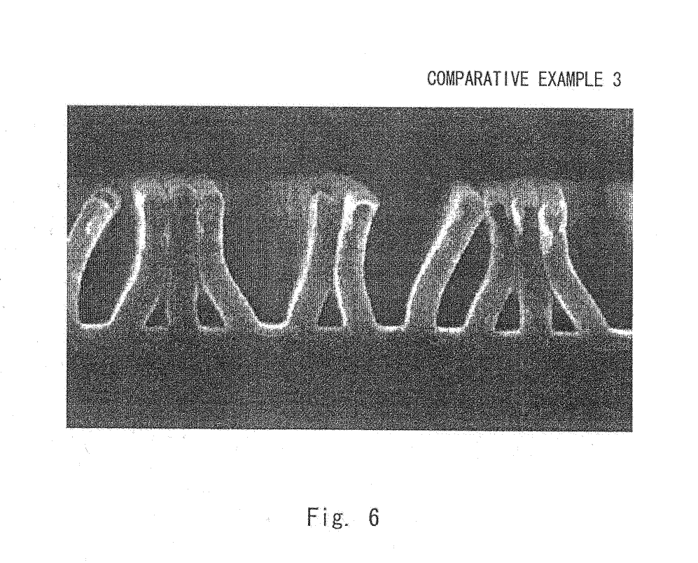

Next, in a similar manner to the example 2, an adhesion layer and a release layer were sequentially laminated over the surface of the mold body with the base film so as to obtain a mold with the base film. The surface of the mold body was bleached in a macroscopic observation. From an SEM observation of the pattern shape of the mold body, sticking occurred in which the adjacent protrusions were associated and a substantial upright pattern was not achieved. FIG. 6 is an SEM cross-sectional photograph of the mold. In this example, sticking occurred in the lamination process of the release layer during fabrication of the mold.

The fabrication conditions for the mold and evaluation results in the examples 1 and 2, the reference example 1, and the comparative examples 1 to 3 are shown in tables 1 and 2. The upright property of the pattern is indicated such that “good” means no sticking and “poor” means sticking occurred.

The fabrication method of the resin compact according to the present invention can be applied to a resin compact including a nano-order uneven pattern.

TABLE 1

| | Mold | | | | | | | | | | |
|---|---|---|---|---|---|---|---|---|---|---|---|
| | Rein mold body | | | | | | | | | | Resin compact |
| | | | | | | Martens | Pattern upright | Adhesion | Release | Pattern upright | Pattern upright |
| | a | b | c | b/a | c/b | hardness | property | layer | layer | property | property |
| Example 1 | 50 | 150 | 50 | 3 | 0.33 | 200 | good | Yes | Yes | good | good |
| Reference Example1 | 50 | 100 | 50 | 2 | 0.50 | 120 | good | Yes | Yes | good | good |
| Comparative example 1 | 50 | 150 | 50 | 3 | 0.33 | 120 | poor | — | — | — | — |
| Comparative example 2 | 50 | 150 | 50 | 3 | 0.33 | 180 | good | Yes | Yes | poor | — |

TABLE 2

| | Mold | | | | | | | | | | |
|---|---|---|---|---|---|---|---|---|---|---|---|
| | Mold body | | | | | | | | | Pattern | Resin compact |
| | | | | | | Martens | Pattern upright | Adhesion | Release | upright | Pattern upright |
| | a | b | c | b/a | c/b | hardness | property | layer | layer | property | property |
| Example 2 | 100 | 400 | 100 | 4 | 0.25 | 150 | good | Yes | Yes | good | good |
| Comparative example 3 | 100 | 400 | 100 | 4 | 0.25 | 130 | good | Yes | Yes | poor | — |

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of fabricating a resin compact including an uneven pattern on a surface, the method comprising:
a process (A) that prepares a resin mold body including an inversion pattern of the uneven pattern and prepares a mold including an adhesion layer and a release layer that are sequentially laminated over the inversion pattern according to a pattern shape of the inversion pattern, the inversion pattern including a plurality of depressions and a plurality of protrusions, satisfying any one of conditions which are:
a width of the protrusion is 5 nm or greater and less than 50 nm and an aspect ratio of the protrusion is 2 or greater;
the width of the protrusion is 50 nm or greater and less than 100 nm and the aspect ratio of the protrusion is 3 or greater; and
the width of the protrusion is 100 nm or greater and less than 1 μm and the aspect ratio of the protrusion is 4 or greater,
the inversion pattern having a space between the adjacent protrusions less than twice a height of the protrusion,
and the inversion pattern having Martens hardness of 200 or greater when the width of the protrusion is 5 nm or greater and less than 100 nm and Martens hardness of 150 or greater when the width of the protrusion is 100 nm or greater and less than 1 μm,
a process (B) that supplies curable resin on the inversion pattern of the mold and cures the curable resin to thereby form the resin compact over the mold; and
a process (C) that releases the resin compact from the mold.

2. The method according to claim 1, wherein the inversion pattern is a pattern in which an angle of a side surface of the protrusion to a bottom surface of the depression is 80 to 90 degrees.

3. The method according to claim 1, wherein the adhesion layer contains metal and/or metal oxide.

4. The method according to claim 1, wherein in the process (A), after the mold body with the adhesion layer formed thereon is immersed in a solution containing a release agent such as a fluorine series, a silicone series, or a hydrocarbon series, the mold body is dried to thereby form the release layer.

5. The method according to claim 1, wherein the processes (B) to (D) are conducted by roll-to-roll processing.

6. A resin compact fabricated by the method according to claim 1.

7. A mold used for fabricating a resin compact including an uneven pattern on a surface, the mold comprising:
a resin mold body including an inversion pattern of the uneven pattern, the inversion pattern including a plurality of depressions and a plurality of protrusions, satisfying any one of conditions which are:
a width of the protrusion is 5 nm or greater and less than 50 nm and an aspect ratio of the protrusion is 2 or greater;
the width of the protrusion is 50 nm or greater and less than 100 nm and the aspect ratio of the protrusion is 3 or greater; and
the width of the protrusion is 100 nm or greater and less than 1 μm and the aspect ratio of the protrusion is 4 or greater,
the inversion pattern having a space between the adjacent protrusions less than twice a height of the protrusion,
and the inversion pattern having Martens hardness of 200 or greater when the width of the protrusion is 5 nm or greater and less than 100 nm and Martens hardness of 150 or greater when the width of the protrusion is 100 nm or greater and less than 1 μm, and
an adhesion layer and a release layer, the adhesion layer and the release layer being sequentially laminated over the inversion pattern according to a pattern shape of the inversion pattern.

8. The mold according to claim 7, wherein the inversion pattern is a pattern in which an angle of a side surface of the protrusion to a bottom surface of the depression is 80 to 90 degrees.

9. The mold according to claim 7, wherein the mold body is fabricated by a nanoimprint method.
